(19) United States
(12) Patent Application Publication
(10) Pub. No.: US 2024/0118063 A1
(43) Pub. Date: Apr. 11, 2024

(54) LIGHTED ARROW

(71) Applicant: FERADYNE OUTDOORS, LLC, Superior, WI (US)

(72) Inventors: Sam Voigt, Duluth, MN (US); Nick Cotton, Duluth, MN (US); Kevin Berggren, Duluth, MN (US); Dan Loeffler, Duluth, MN (US)

(21) Appl. No.: 18/377,990

(22) Filed: Oct. 9, 2023

Related U.S. Application Data
(60) Provisional application No. 63/378,776, filed on Oct. 7, 2022.

(51) Int. Cl. F42B 6/06; F21K 2/06; F21V 33/00

(52) U.S. Cl. CPC F42B 6/06; F21K 2/06; F21V 33/008

(57) ABSTRACT

A lighted arrow shaft includes a cylindrical shaft having a first end and a second end. The second end is opposite the first end. A tip is secured to the cylindrical shaft at the first end. A non-powered light source is disposed within the shaft.

### CROSS-REFERENCE TO RELATED APPLICATION

This application claims priority to U.S. Provisional Patent Application No. 63/378,776, filed Oct. 7, 2022, entitled “LIGHTED ARROW”, which is incorporated herein by reference in its entirety.

### FIELD

This disclosure relates generally to the field of archery. More particularly, this disclosure relates to shafts for an arrow such as, but not limited to, a lighted shaft for an arrow.

### BACKGROUND

A lighted arrow allows an archer to be able to see the arrow more easily in flight, see the point of arrow impact, and recover the arrow after a shot, especially at night. Being able to observe the arrow in flight and see the point of impact helps the archer to diagnose problems with shooting form or bow setup and make appropriate adjustments. Perhaps more importantly, a lighted arrow shaft allows the archer to recover the arrow more easily.

### SUMMARY

In some embodiments, a device includes a shaft having a first end and a second end. In some embodiments, the second end is opposite the first end. In some embodiments, a tip is secured to the first end of the shaft. In some embodiments, a non-powered light source is disposed within at least a portion of the shaft.

In some embodiments, the shaft is translucent.

In some embodiments, the shaft is opaque and includes a plurality of apertures.

In some embodiments, the non-powered light source is a glowstick.

In some embodiments, the non-powered light source is configured to emit a red light, a green light, a blue light, a purple light, a yellow light, or any combination thereof.

In some embodiments, a spacer is secured to one of the tip or the second end of the shaft.

In some embodiments, a nock is secured to the spacer.

In some embodiments, the tip is removable from the shaft. In some embodiments, the non-powered light source is configured to be inserted into the shaft at the first end.

In some embodiments, the non-powered light source is configured to be inserted into the shaft at the second end.

In some embodiments, the non-powered light source is configured to be inserted into the shaft between the first end and the second end.

In some embodiments, the device is an arrow.

In some embodiments, the shaft has a first length and the non-powered light source has a second length, wherein the first length is greater than the second length.

In some embodiments, the second length is at least ⅛ of the first length.

In some embodiments, lighted arrow shaft includes a cylindrical shaft having a first end and a second end. In some embodiments, the second end is opposite the first end. In some embodiments, a tip is secured to the cylindrical shaft at the first end. In some embodiments, a non-powered light source is disposed within the cylindrical shaft.

In some embodiments, the cylindrical shaft is translucent.

In some embodiments, the cylindrical shaft is opaque and comprises a plurality of apertures.

In some embodiments, the non-powered light source is a glowstick.

In some embodiments, the non-powered light source is configured to emit a red light, a green light, a blue light, a purple light, a yellow light, or any combination thereof.

In some embodiments, a spacer is secured to one of the tip or the second end of the cylindrical shaft.

In some embodiments, a nock is secured to the spacer at the second end of the cylindrical shaft.

In some embodiments, the non-powered light source is configured to be inserted into the cylindrical shaft at the first end.

In some embodiments, the non-powered light source is configured to be inserted into the cylindrical shaft at the second end.

In some embodiments, the non-powered light source is configured to be inserted into the cylindrical shaft between the first end and the second end.

In some embodiments, the cylindrical shaft has a first length and the non-powered light source has a second length, wherein the second length is at least ⅛ of the first length.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a perspective view of a lighted arrow, according to some embodiments.

FIG. 2 shows an exploded view of a first portion of the lighted arrow of FIG. 1, according to some embodiments.

FIG. 3 shows an exploded view of a second portion of the lighted arrow of FIG. 1, according to some embodiments.

FIG. 4 shows a perspective view of a lighted arrow, according to some embodiments.

FIG. 5 shows an exploded view of a first portion of the lighted arrow of FIG. 4, according to some embodiments.

FIG. 6 shows an exploded view of a second portion of the lighted arrow of FIG. 4, according to some embodiments.

FIG. 7 shows a perspective view of a lighted arrow, according to some embodiments.

FIG. 8 shows an exploded view of a portion of the lighted arrow of FIG. 7, according to some embodiments.

Like reference numbers represent the same or similar parts throughout.

### DETAILED DESCRIPTION

Embodiments of this disclosure include a lighted arrow. In particular, the lighted arrow includes a lighted shaft. In some embodiments, the lighted arrow can include a translucent hollow arrow shaft which is designed to receive and retain a long cylindrical glowstick which may run a majority of the length of the lighted arrow. In some embodiments, the light source can illuminate the arrow to aid in seeing the arrow's flight. The lighted arrow can be designed such that the glowstick can be inserted into either the forward or tip end of the arrow shaft or the tail portion of the arrow shaft. In some embodiments, the lighted arrow can make it easier for archers or bow fishermen to see an arrow upon firing and to assist in arrow locating and retrieving the arrows.

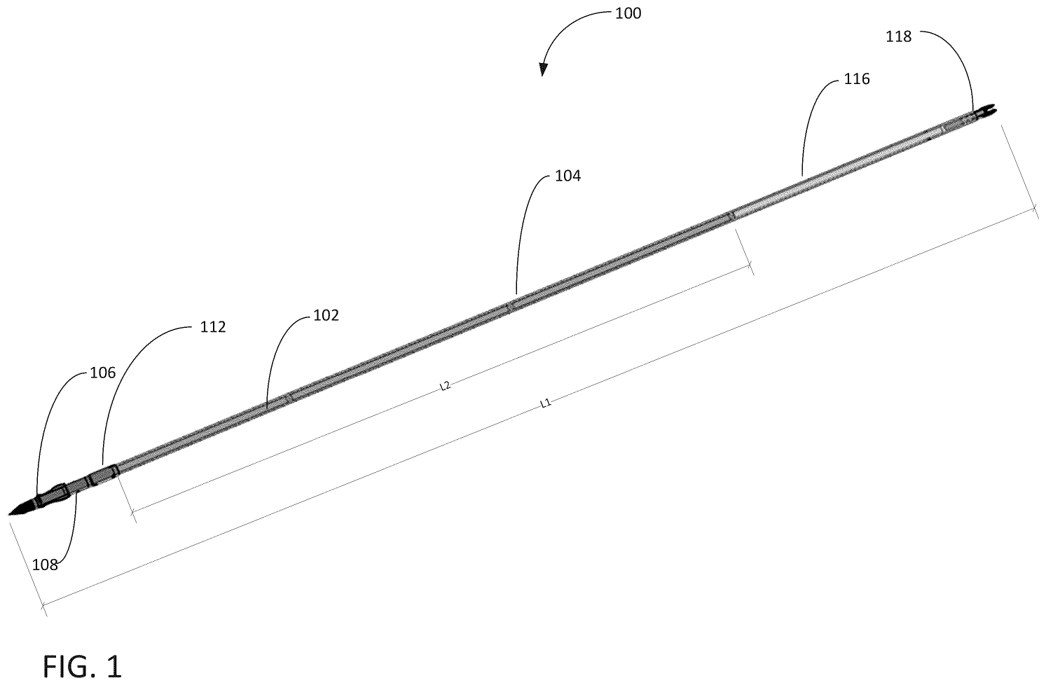

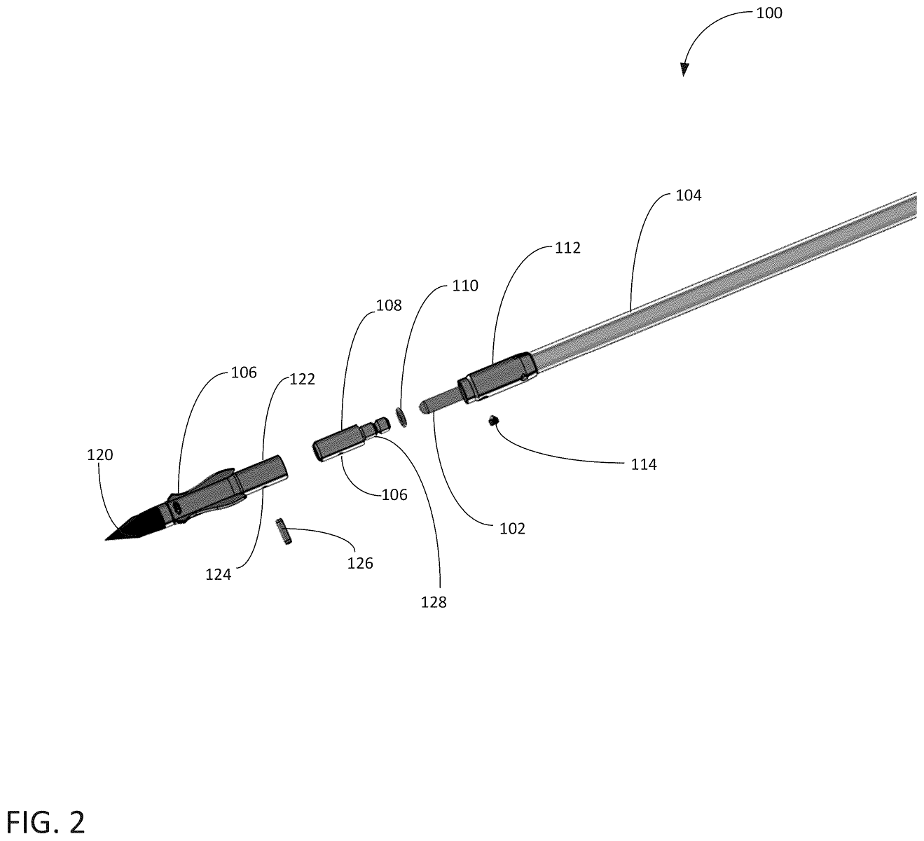

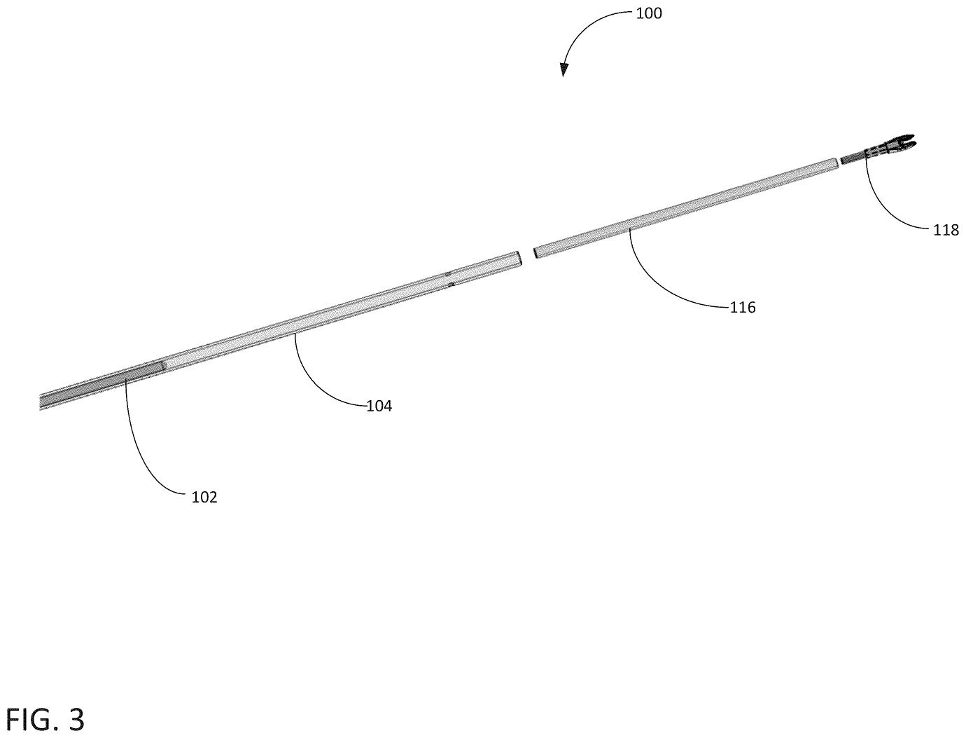

FIG. 1 shows a perspective view of a lighted arrow 100, according to some embodiments. FIG. 2 shows an exploded view of a first portion of the lighted arrow 100 of FIG. 1, according to some embodiments. In some embodiments, the first portion of the lighted arrow 100 in FIG. 2 may be referred to as a tip portion of the lighted arrow 100. FIG. 3 shows an exploded view of a second portion of the lighted arrow 100 of FIG. 1, according to some embodiments. In some embodiments, the second portion of the lighted arrow 100 may be referred to as a tail portion of the lighted arrow 100. FIGS. 1-3 will be referred to collectively unless specifically noted otherwise.

In some embodiments, the lighted arrow 100 can be referred to as a forward loading arrow, according to some embodiments. In some embodiments, this can be because a location of a light source in the lighted arrow 100 is accessible through a portion of the lighted arrow 100 that is nearer to a tip of the lighted arrow 100 than a tail of the lighted arrow 100.

In some embodiments, the lighted arrow 100 can be configured to have a light source 102. In some embodiments, the light source 102 can be inserted into a shaft 104. The lighted arrow 100 can be loaded with the light source 102 from a front portion of the lighted arrow 100. It is to be appreciated that loading the light source 102, as used herein, can include removal of the light source 102, addition of the light source 102, or combinations thereof.

The lighted arrow 100 includes the light source 102, the shaft 104, a tip 106, a first adapter 108, a seal 110, a second adapter 112, and a fastener 114. The lighted arrow 100 also includes a spacer 116 and a nock 118. In some embodiments, the nock 118 may not be present. For example, for applications including a crossbow, the nock 118 may not be included in the lighted arrow 100.

In some embodiments, the light source 102 can be a temporary light source such as, but not limited to, a glowstick or the like.

In some embodiments, a length of the lighted arrow 100 can be L1. In some embodiments, a length of the light source 102 can be L2. In some embodiments, the length L1 of the lighted arrow 100 can be greater than a length of the light source L2 For example, the lighted arrow 100 can be lit for half the length L1, a quarter of the length L1, or any other variation that is less than the length L1. In some embodiments, the length L2 is at least ⅛ of the length L1.

In some embodiments, the light source 102 can be activated by a user and then inserted into the shaft 104. In some embodiments, the light source 102 can be a glowstick. In some embodiments, the light source 102 can include a cylinder containing a plurality of chemicals. In some embodiments, the plurality of chemicals can include hydrogen peroxide and tort-butyl alcohol. In some embodiments, the hydrogen peroxide can be encased in a vessel suspended within the tort-butyl alcohol. In some embodiments, when a user wants to activate the light source 102, the user can crack the hydrogen peroxide vessel causing the two liquids to mix, which creates a glowing chemical reaction. In some embodiments, the reaction can last from 4-12 hours. In some embodiments, once the glowing reaction fades, the user may discard the light source 102 and activate another of the light source 102 and install it into the shaft 104. It is to be appreciated that the light source 102 is an example, and that other non-powered light sources causing a temporary glowing may be used in accordance with embodiments of the present disclosure. As used herein, non-powered light sources include light sources that do not have a battery component.

In some embodiments, a color of the light source 102 can be red or green. In some embodiments, the light source 102 can have a color that is visible during the night but does not cause night blindness of the user. It is to be appreciated that these colors are examples and other colors may be possible for the light source 102. In some embodiments, the light source 102 can emanate a red light, a green light, a blue light, a purple light, a yellow light, or any combination thereof.

In some embodiments, the shaft 104 can be made of a translucent material. In some embodiments, the shaft 104 can be made of an opaque material but have one or more apertures formed in the lighted arrow 100 along the length L1 to allow light to be emitted from the shaft 104. The principles of the shaft 104 are equally applicable to all forms of transparent or translucent materials. In addition, opaque materials may also be used when slots, holes, or other apertures are provided to allow the light to escape. Accordingly, the present disclosure is not limited to any type of material or fabrication method for producing the device. In some embodiments, suitable materials for the shaft 104 include, but are not limited to, plastic, polycarbonate, compounds thereof and the like, all of which are well known in the art for their suitability for arrows.

In some embodiments, the tip 106 includes a point 120. In the illustrated embodiment, the tip 106 includes a housing 122 configured to receive the first adapter 108. An aperture 124 can be formed in the housing 122 to receive a pin 126 once the first adapter 108 is installed in the housing 122 to maintain the first adapter 108 in the housing 122.

The second adapter 112 is configured to be secured to the shaft 104. In some embodiments, the second adapter 112 can be molded as part of the shaft 104. In some embodiments, the second adapter 112 can be secured to the shaft 104 by a fastener such as a set screw or the like. In some embodiments, the second adapter 112 can be secured to the shaft 104 by, for example, welding, adhesives, a press-fit, or the like. The second adapter 112 is configured to be mated with the first adapter 108. For example, the second adapter 112 can receive a portion 128 of the first adapter 108. Once mated, the first adapter 108 and the second adapter 112 can be secured together by, for example, the fastener 114 which can include, for example, a set screw or the like. It is to be appreciated that the first adapter 108 and the second adapter 112 can be secured by a different connection type, for example, a press fit, a snap connection, a threaded connection, or the like. In some embodiments, the seal 110 can be included to provide a sealing connection between the first adapter 108 and the second adapter 112. This can be beneficial since the lighted arrow 100 can typically be used when bowfishing. Thus, the seal 110 can prevent the lighted arrow 100 from filling with water or other contaminants. In some embodiments, the seal 110 can be an O-ring or the like.

In some embodiments, the tail portion of the lighted arrow 100 can include a spacer 116. In some embodiments, the spacer 116 can be a portion of the shaft that is not translucent, not hollow, or combinations thereof. In some embodiments, the spacer 116 can be used to control an overall weight of the lighted arrow 100. That is, a weight of the spacer 116 can be variable.

In some embodiments, the lighted arrow 100 can weigh less than 1,400 grains. In some embodiments, the lighted arrow 100 can be made to weigh more than 1,400 grains to provide a weighted arrow such as, but not limited to, for bowfishing or the like.

In some embodiments, the lighted arrow 100 can weigh from 600 grains to 2,000 grains. In some embodiments, the lighted arrow 100 can weigh from 800 grains to 1,500 grains. In some embodiments, the lighted arrow 100 can weigh from 1,000 grains to 1,200 grains. In some embodiments, the lighted arrow 100 can weigh less than 1,000 grains.

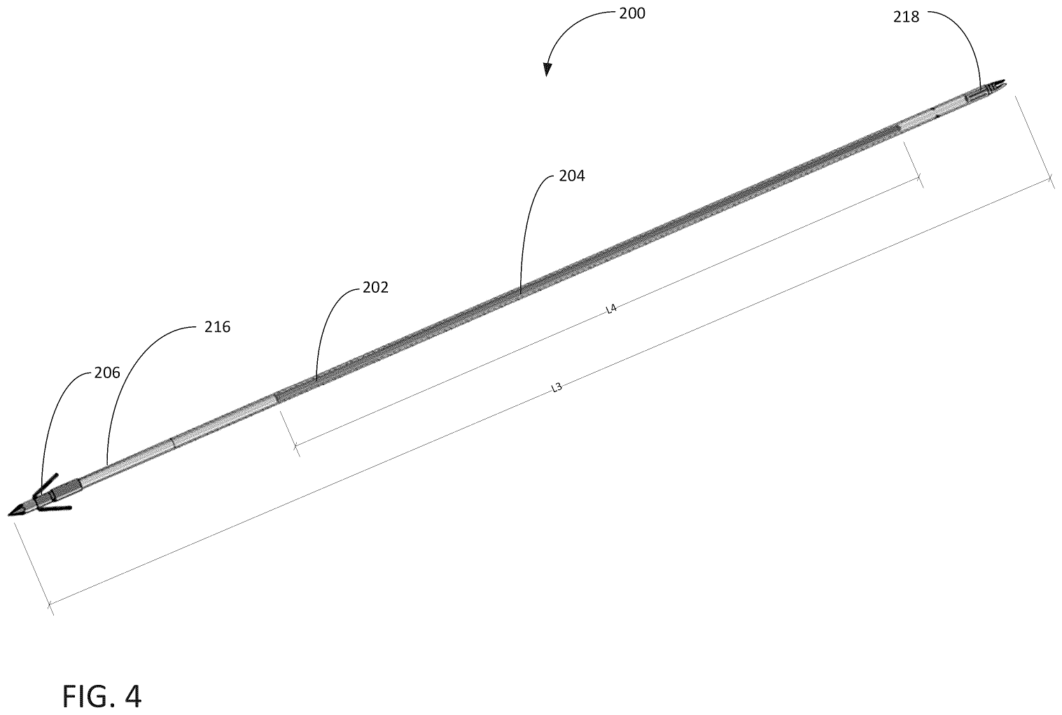

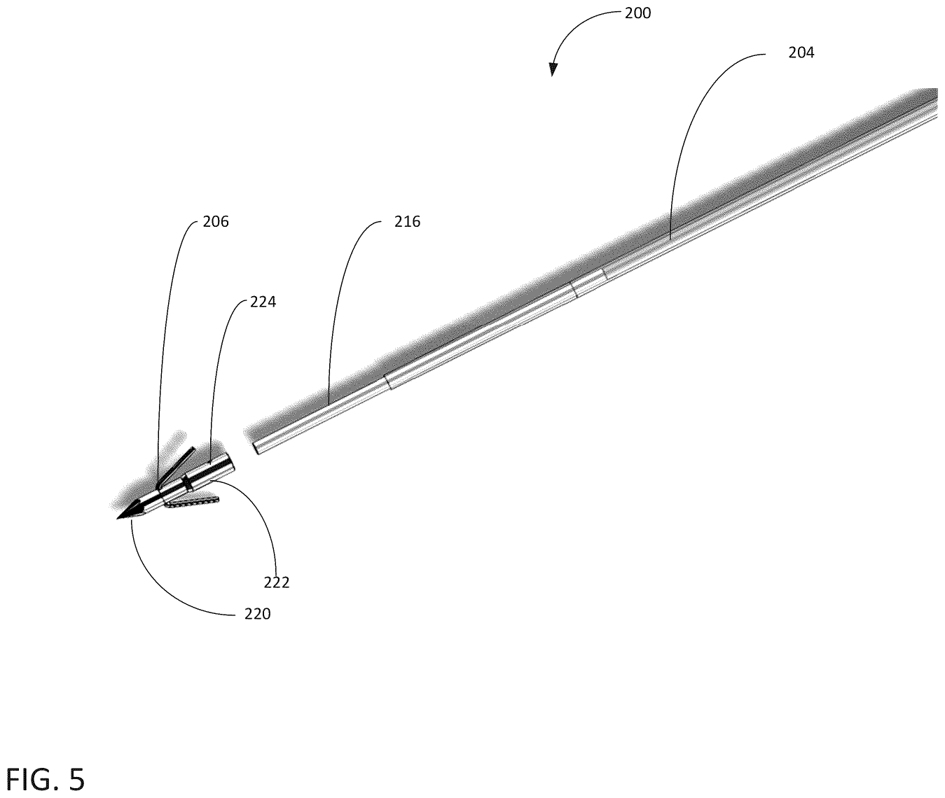

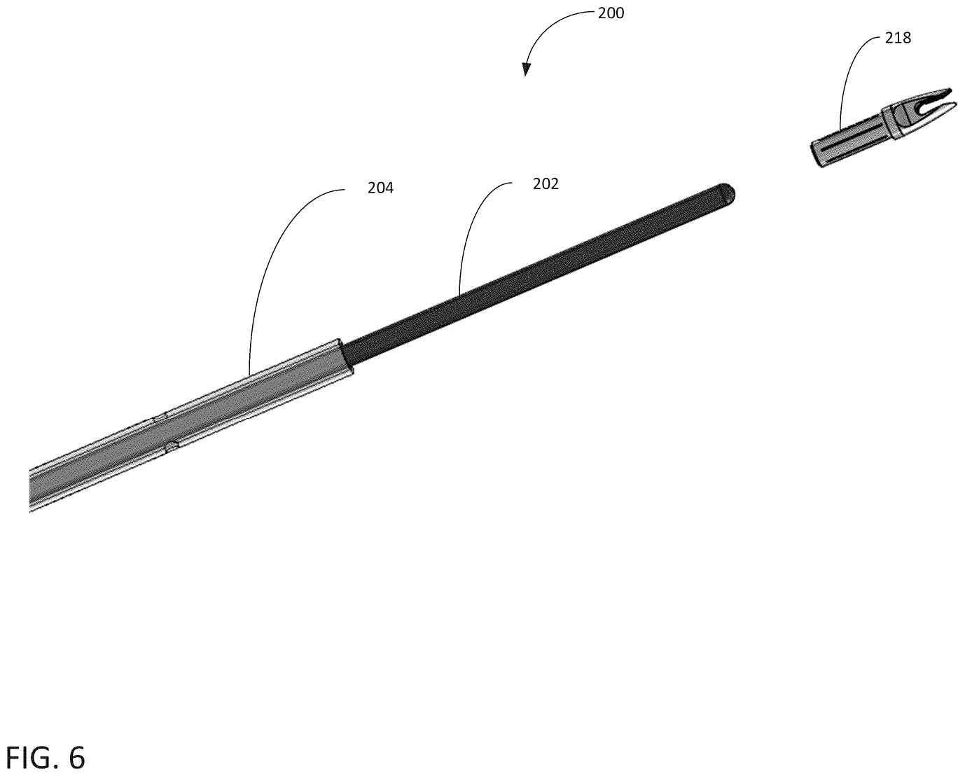

FIG. 4 shows a perspective view of a lighted arrow 200, according to some embodiments. FIG. 5 shows an exploded view of a first portion of the lighted arrow 200 of FIG. 4, according to some embodiments. In some embodiments, the first portion of the lighted arrow 200 in FIG. 5 may be referred to as a tip portion of the lighted arrow 200. FIG. 6 shows an exploded view of a second portion of the lighted arrow 200 of FIG. 4, according to some embodiments. In some embodiments, the second portion of the lighted arrow 200 may be referred to as a tail portion of the lighted arrow 200. FIGS. 4-6 will be referred to collectively unless specifically noted otherwise.

In some embodiments, the lighted arrow 200 can be referred to as a rear loading arrow, according to some embodiments. In some embodiments, this can be because a location of a light source in the lighted arrow 200 is accessible through a portion of the lighted arrow 200 that is nearer to a tail of the lighted arrow 200 than a tip of the lighted arrow 200.

In some embodiments, the lighted arrow 200 can be configured to have a light source 202. In some embodiments, the light source 202 can be inserted into a shaft 204. The lighted arrow 200 can be loaded with the light source 202 from a tail portion of the lighted arrow 200. It is to be appreciated that loading the light source 202, as used herein, can include removal of the light source 202, addition of the light source 202, or combinations thereof.

The lighted arrow 200 includes the light source 202, the shaft 204, and a tip 206. The lighted arrow 200 also includes a spacer 216 and a nock 218. In some embodiments, the nock 218 may not be present. For example, for applications including a crossbow, the nock 218 may not be included in the lighted arrow 200.

In some embodiments, the light source 202 can be a temporary light source such as, but not limited to, a glowstick or the like.

In some embodiments, a length of the lighted arrow 200 can be L3. In some embodiments, a length of the light source 202 can be L4. In some embodiments, the length L3 of the lighted arrow 200 can be greater than a length of the light source L4 For example, the lighted arrow 200 can be lit for half the length L3, a quarter of the length L3, or any other variation that is less than the length L3. In some embodiments, the length L4 is at least ⅛ of the length L3.

In some embodiments, the light source 202 can be activated by a user and then inserted into the shaft 204. In some embodiments, the light source 202 can be a glowstick. In some embodiments, the light source 202 can include a cylinder containing a plurality of chemicals. In some embodiments, the plurality of chemicals can include hydrogen peroxide and tert-butyl alcohol. In some embodiments, the hydrogen peroxide can be encased in a vessel suspended within the tert-butyl alcohol. In some embodiments, when a user wants to activate the light source 202, the user can crack the hydrogen peroxide vessel causing the two liquids to mix, which creates a glowing chemical reaction. In some embodiments, the reaction can last from 4-12 hours. In some embodiments, once the glowing reaction fades, the user may discard the light source 202 and activate another of the light source 202 and install it into the shalt 204. It is to be appreciated that the light source 202 is an example, and that other non-powered light sources causing a temporary glowing may be used in accordance with embodiments of the present disclosure. As used herein, non-powered light sources include light sources that do not have a battery component.

In some embodiments, a color of the light source 202 can be red or green. In some embodiments, the light source 202 can have a color that is visible during the night but does not cause night blindness of the user. It is to be appreciated that these colors are examples and other colors may be possible for the light source 202. In some embodiments, the light source 202 can emanate a red light, a green light, a blue light, a purple light, a yellow light, or any combination thereof.

In some embodiments, the shaft 204 can be made of a translucent material. In some embodiments, the shaft 204 can be made of an opaque material but have one or more apertures formed in the lighted arrow 200 along the length L3 to allow light to be emitted from the shaft 204. The principles of the shaft 204 are equally applicable to all forms of transparent or translucent materials. In addition, opaque materials may also be used when slots, holes, or other apertures are provided to allow the light to escape. Accordingly, the present disclosure is not limited to any type of material or fabrication method for producing the device. In some embodiments, suitable materials for the shaft 204 include, but are not limited to, plastic, polycarbonate, compounds thereof and the like, all of which are well known in the art for their suitability for arrows.

In some embodiments, the tip 206 includes a point 220. In the illustrated embodiment, the tip 206 includes a housing 222 configured to receive the spacer 216. An aperture 224 can be formed in the housing 222 to receive a pin once the spacer 216 is installed in the housing 222 to maintain the spacer 216 in the housing 222. In some embodiments, the spacer 216 can be a portion of the shaft that is not translucent, not hollow, or combinations thereof. In some embodiments, the spacer 216 can be used to control an overall weight of the lighted arrow 200. That is, a weight of the spacer 216 can be variable.

In some embodiments, the nock 218 can be inserted into an end of the shaft 204 to secure the light source 202 therein. In some embodiments, such as those without the nock 218, a cap or other closure for the shaft 204 can be included.

In some embodiments, the lighted arrow 200 can weigh less than 1,400 grains. In some embodiments, the lighted arrow 200 can be made to weigh more than 1,400 grains to provide a weighted arrow such as, but not limited to, for bowfishing or the like.

In some embodiments, the lighted arrow 200 can weigh from 600 grains to 2,000 grains. In some embodiments, the lighted arrow 200 can weigh from 800 grains to 1,500 grains. In some embodiments, the lighted arrow 200 can weigh from 1,000 grains to 1,200 grains. In some embodiments, the lighted arrow 200 can weigh less than 1,000 grains.

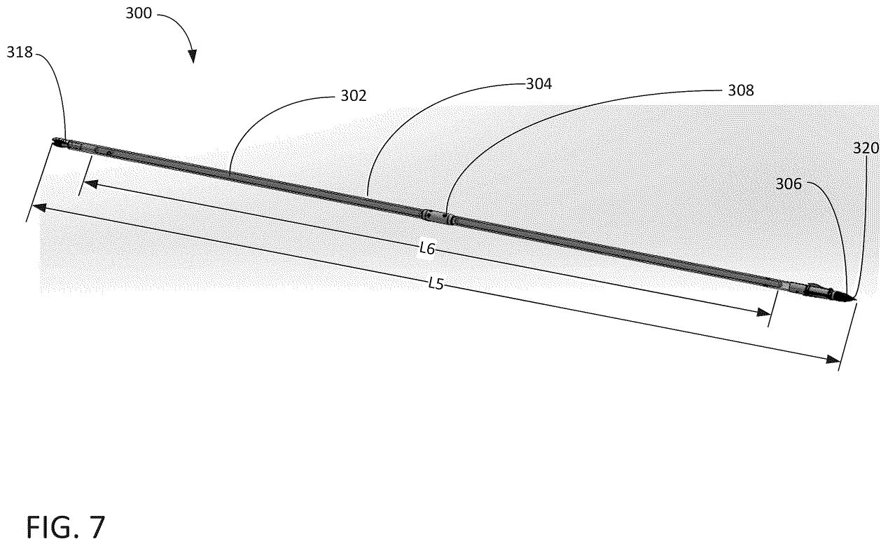

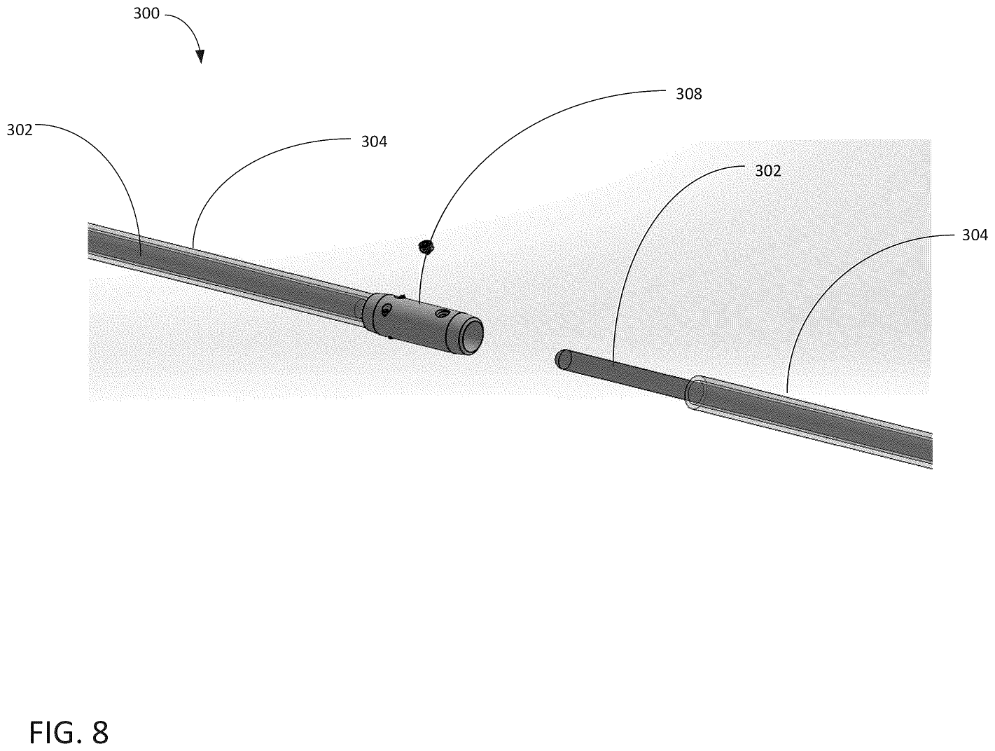

FIG. 7 shows a perspective view of a lighted arrow 300, according to some embodiments. FIG. 8 shows an exploded view of a portion of the lighted arrow 300 of FIG. 7, according to some embodiments. FIGS. 7 and 8 will be referred to collectively unless specifically noted otherwise.

In some embodiments, the lighted arrow 300 can be referred to as a middle loading arrow, according to some embodiments. In some embodiments, this can be because a location of a light source in the lighted arrow 300 is accessible through a portion of the lighted arrow 300 that is about a same distance from a tail of the lighted arrow 300 than a tip of the lighted arrow 300.

In some embodiments, the lighted arrow 300 can be configured to have a light source 302. In some embodiments, the light source 302 can be inserted into a shaft 304. The lighted arrow 300 can be loaded with the light source 302 from a portion of the lighted arrow 300 that is about a mid-point between a tip portion and a tail portion of the lighted arrow 300. It is to be appreciated that loading the light source 302, as used herein, can include removal of the light source 302, addition of the light source 302, or combinations thereof.

The lighted arrow 300 includes the light source 302, the shaft 304, and a tip 306. The lighted arrow 300 can also include a connector 308 configured to connect two portions of the shaft 304. In some embodiments, the connector 308 can be secured to the shaft 304 via, for example, set screws or the like. In some embodiments, the shaft 304 can be welded or otherwise fixed to one of the portions of the shaft 304 and then connected via a set screw to the other portion of the shaft 304.

The lighted arrow 300 can include a spacer and also includes a nock 318. In some embodiments, the nock 318 may not be present. For example, for applications including a crossbow, the nock 318 may not be included in the lighted arrow 300.

In some embodiments, the light source 302 can be a temporary light source such as, but not limited to, a glowstick or the like.

In some embodiments, a length of the lighted arrow 300 can be L5. In some embodiments, a length of the light source 302 can be L6. In some embodiments, the length L5 of the lighted arrow 300 can be greater than a length of the light source L6 For example, the lighted arrow 300 can be lit for half the length L5, a quarter of the length L5, or any other variation that is less than the length L5. In some embodiments, the length L6 is at least ⅛ of the length L5.

In some embodiments, the lighted arrow 300 can include more than one of the light source 302. For example, in the illustrated embodiment of FIG. 8, the lighted arrow 300 can include a first of the light source 302 in a first portion of the shaft 304 and a second of the light source 302 in a second portion of the shaft 304. In such embodiments, the light source 302 does not have to be identical to the other light source 302. In some embodiments, both of the light source 302 are the same.

In some embodiments, the light source 302 can be activated by a user and then inserted into the shaft 304. In some embodiments, the light source 302 can be a glowstick. In some embodiments, the light source 302 can include a cylinder containing a plurality of chemicals. In some embodiments, the plurality of chemicals can include hydrogen peroxide and tert-butyl alcohol. In some embodiments, the hydrogen peroxide can be encased in a vessel suspended within the tert-butyl alcohol. In some embodiments, when a user warns to activate the light source 302, the user can crack the hydrogen peroxide vessel causing the two liquids to mix, which creates a glowing chemical reaction. In some embodiments, the reaction can last from 4-12 hours. In some embodiments, once the glowing reaction fades, the user may discard the light source 302 and activate another of the light source 302 and install it into the shaft 304. It is to be appreciated that the light source 302 is an example, and that other non-powered light sources causing a temporary glowing may be used in accordance with embodiments of the present disclosure. As used herein, non-powered light sources include light sources that do not have a battery component.

In some embodiments, a color of the light source 302 can be red or green. In some embodiments, the light source 302 can have a color that is visible during the night but does not cause night blindness of the user. It is to be appreciated that these colors are examples and other colors may be possible for the light source 302. In some embodiments, the light source 302 can emanate a red light, a green light, a blue light, a purple light, a yellow light, or any combination thereof.

In some embodiments, the shaft 304 can be made of a translucent material. In some embodiments, the shaft 304 can be made of an opaque material but have one or more apertures formed in the lighted arrow 300 along the length L5 to allow light to be emitted from the shaft 304. The principles of the shaft 304 are equally applicable to all forms of transparent or translucent materials. In addition, opaque materials may also be used when slots, holes, or other apertures are provided to allow the light to escape. Accordingly, the present disclosure is not limited to any type of material or fabrication method for producing the device. In some embodiments, suitable materials for the shaft 304 include, but are not limited to, plastic, polycarbonate, compounds thereof and the like, all of which are well known in the art for their suitability for arrows.

In some embodiments, the tip 306 includes a point 320. In some embodiments, the nock 318 can be inserted into an end of the shaft 304 to secure the light source 302 therein. In some embodiments, such as those without the nock 318, a cap or other closure for the shaft 304 can be included.

In some embodiments, the lighted arrow 300 can weigh less than 1,400 grains. In some embodiments, the lighted arrow 300 can be made to weigh more than 1,400 grains to provide a weighted arrow such as, but not limited to, for bowfishing or the like.

In some embodiments, the lighted arrow 300 can weigh from 600 grains to 2,000 grains. In some embodiments, the lighted arrow 300 can weigh from 800 grains to 1,500 grains. In some embodiments, the lighted arrow 300 can weigh from 1,000 grains to 1,200 grains. In some embodiments, the lighted arrow 300 can weigh less than 1,000 grains.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A device, comprising:
a shaft having a first end and a second end,
wherein the second end is opposite the first end;
a tip secured to the first end of the shaft; and
a non-powered light source disposed within at least a portion of the shaft.

2. The device of claim 1, wherein the shaft is translucent.

3. The device of claim 1, wherein the shaft is opaque and comprises a plurality of apertures.

4. The device of claim 1, wherein the non-powered light source is a glowstick.

5. The device of claim 4, wherein the non-powered light source is configured to emit a red light, a green light, a blue light, a purple light, a yellow light, or any combination thereof.

6. The device of claim 1, further comprising a spacer secured to one of the tip or the second end of the shaft.

7. The device of claim 6, further comprising a nock secured to the spacer.

8. The device of claim 6, wherein the tip is removable from the shaft, and wherein the non-powered light source is configured to be inserted into the shaft at the first end.

9. The device of claim 6, wherein the non-powered light source is configured to be inserted into the shaft at the second end.

10. The device of claim 1, wherein the non-powered light source is configured to be inserted into the shaft between the first end and the second end.

11. The device of claim 1, wherein the device is an arrow.

12. The device of claim 1, wherein the shaft has a first length and the non-powered light source has a second length, wherein the first length is greater than the second length.

13. The device of claim 12, wherein the second length is at least ⅛ of the first length.

14. A lighted arrow shaft, comprising:
a cylindrical shaft having a first end and a second end,
wherein the second end is opposite the first end;
a tip secured to the cylindrical shaft at the first end; and
a non-powered light source disposed within the cylindrical shaft.

15. The lighted arrow shaft of claim 14, wherein the cylindrical shaft is translucent.

16. The lighted arrow shaft of claim 14, wherein the cylindrical shaft is opaque and comprises a plurality of apertures.

17. The lighted arrow shaft of claim 14, wherein the non-powered light source is a glowstick.

18. The lighted arrow shaft of claim 17, wherein the non-powered light source is configured to emit a red light, a green light, a blue light, a purple light, a yellow light, or any combination thereof.

19. The lighted arrow shaft of claim 14, further comprising a spacer secured to one of the tip or the second end of the cylindrical shaft.

20. The lighted arrow shaft of claim 19, further comprising a nock secured to the spacer at the second end of the cylindrical shaft.

21. The lighted arrow shaft of claim 19, wherein the non-powered light source is configured to be inserted into the cylindrical shaft at the first end.

22. The lighted arrow shaft of claim 19, wherein the non-powered light source is configured to be inserted into the cylindrical shaft at the second end.

23. The lighted arrow shaft of claim 14, wherein the non-powered light source is configured to be inserted into the cylindrical shaft between the first end and the second end.

24. The lighted arrow shaft of claim 14, wherein the cylindrical shaft has a first length and the non-powered light source has a second length, wherein the second length is at least ⅛ of the first length.
